(19) United States
(12) Patent Application Publication
(10) Pub. No.: US 2005/0191059 A1
(43) Pub. Date: Sep. 1, 2005

(54) Use of low-speed components in high-speed optical fiber transceivers

(75) Inventors: Norman Swenson, Mountain View, CA (US); Paul Voois, Ladera Ranch, CA (US)

Correspondence Address: SIERRA PATENT GROUP, LTD., P O BOX 6149, STATELINE, NV, 89449, US

(73) Assignee: Clariphy

(21) Appl. No.: 11/033,457

(22) Filed: Jan. 10, 2005

Related U.S. Application Data
(60) Provisional application No. 60/536,148, filed on Jan. 12, 2004.
(60) Provisional application No. 60/541,674, filed on Feb. 3, 2004.

(51) Int. Cl. H04B 10/00

(52) U.S. Cl. 398/159

(57) ABSTRACT

An optical communication link is disclosed. In one embodiment, the link includes an optical transmitter including an electrical-to-optical converter for converting electrical signals into optical signals at the system data rate and launching said signals onto an extended length of optical fiber. The link also includes an optical receiver including an optical-to-electrical converter for converting received optical signals into electrical signals. In a preferred embodiment, either of the optical transmitter or optical receiver may include at least one low speed device designed to operate at a data rate less than the system data rate, and the receiver includes an equalizer coupled to the optical-to-electrical converter for compensating for signal distortions introduced by low speed devices.

### RELATED APPLICATIONS

This application claims the priority date established by U.S. Provisional Application Ser. No. 60/536,148, filed on Jan. 12, 2004 and 60/541,674, filed on Feb. 2, 2004.

### BACKGROUND

1. Field of the Disclosure

This application relates generally to optical data communications.

2. Background

Optical fiber is widely used as a communications medium in very high speed digital networks, including local area networks (LANs), storage area networks (SANs), and wide area networks (WANs). The type of fiber used depends on the distances required and the cost sensitivity of the application. Recently, attention has been shifting towards 10 Gigabit systems. Market barriers to widespread adoption of 10 Gbps networking include limitations on achievable distance over installed optical fiber and the high cost of 10 Gbps optical transceivers. The invention described in this disclosure addresses both of these barriers.

### SUMMARY OF THE INVENTION

In one aspect of the invention, 10 Gbps enterprise networking is enabled using existing MMF fiber and less expensive lower speed components. The distortions caused by the lower speed components are mitigated by the use of equalization. In this application, the equalization specifically corrects for effects due to lower speed components.

In another aspect of the invention, an optical communication link for communicating at a given data rate comprises an optical transmitter and an optical receiver, at least one of said optical transmitter or optical receiver including at least one low speed device, said optical receiver further comprising an equalizer for compensating signal distortion introduced by said low speed device.

In another aspect, the presently disclosed invention provides a low-cost extended reach optical fiber link on embedded MMF, while providing significant cost reduction over existing 10 Gbps transceiver solutions. The system of this disclosure achieves significant cost reduction by realizing a 10 Gbps transceiver using lower performance optical and electronic components that are available at much lower cost than corresponding 10 Gbps components. Equalization is used to compensate for the distortion introduced by these components, as well as the distortion introduced by transport over distances of MMF exceeding 26 m, to include 220 m and 300 m of MMF. While MMF is the preferred medium described in this disclosure, the principles can be applied to enable the use of lower cost components when the medium is single mode fiber as well.

### BRIEF DESCRIPTION OF THE DRAWING FIGURES

FIG. 1 is a block diagram of a typical optical communication link.

FIGS. 2a and 2b are block diagrams of modularized optical communication transceivers.

FIG. 3 is a block diagram of a typical optical communication link employing equalization.

FIG. 4 is a block diagram of an optical communication link configured in accordance with the teachings of this disclosure.

FIGS. 5a and 5b are block diagrams of modularized optical communication transceivers configured in accordance with the teachings of this disclosure.

FIG. 6 is a block diagram of a decision feedback equalizer suitable for use with the teachings of this disclosure.

FIG. 7 is a block diagram of an optical communication link channel model configured in accordance with the teachings of this disclosure.

FIGS. 8a and 8b are plots of the modeled output of a laser source comparing results from a nonlinear model with a linear fit to those results.

FIG. 9 is a plot showing the advantage of using lower speed receive components in conjunction with a DFE in accordance with the teachings of this disclosure.

FIG. 10 is a plot showing the power penalties for different combinations of transmit and receive components using a DFE equalizer in accordance with the teachings of this disclosure.

FIG. 11 is a plot showing the power penalties for different combinations of transmit and receive components using PAM4 in accordance with the teachings of this disclosure.

FIG. 12 is a table (Table 1) showing the maximum specified distance for serial signaling over multimode fiber for Fibre Channel and Ethernet.

FIG. 13 is a table (Table 2) showing the noise power spectral density of typical commercial receivers.

FIG. 14 is a table (Table 3) summarizing performance of various link configurations for 300 m transmission.

### DETAILED DESCRIPTION OF PREFERRED EMBODIMENT

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

As used in this disclosure, 10 Gigabit (abbreviated as 10 G or 10 Gbps) systems are understood to include optical fiber communication systems that have data rates or line rates (i.e., bit rates including overhead) of approximately 10 Gigabits per second. The terms data rate and line rate will be used interchangeably, unless the context requires a distinction. These systems include, for example, 10 G Ethernet (10.31250 Gbps), 10 G Fibre Channel (10.51875 Gbps), SONET OC-192 (9.95328 Gbps), SONET OC-192 with FEC (10.70923 Gbps), and 10 G Ethernet with FEC (11.04911 Gbps and 11.09573 Gbps variants). The principles of the disclosed invention can also be applied to 8 G Fibre Channel (8.50000 Gbps) and systems at higher data rates, such as 40 Gbps. In fact, the principles are applicable to any high-speed optical communications system where the optoelectronic components are costly compared to the corresponding components of optical communication systems at lower speeds.

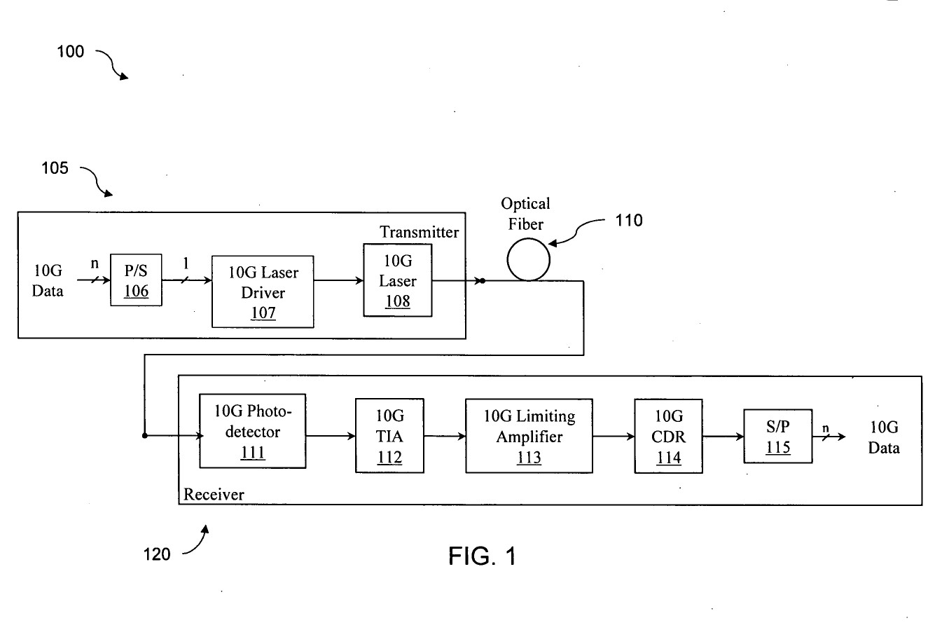

A 10 G optical fiber link 100 is shown in FIG. 1. The link 100 includes a transmitter 105 coupled through optical fiber 110 to a receiver 120. A typical transmitter 105 may include a serializer, or parallel/serial converter (P/S), 106 for receiving 10 G data from a data source on a plurality of parallel lines and providing serial data to a 10 G laser driver 107. The driver 107 then drives a 10 G laser source 108 which launches data on fiber 110.

A typical receiver 120 includes a 10 G photodetector 111 for receiving and detecting data from the fiber 110. The detected data is typically processed through a 10 G transimpedance amplifier 112, a 10 G limiting amplifier 113, and a 10 G clock and data recovery unit 114. The data may then be placed on a parallel data interface through a serial/parallel converter (S/P)115.

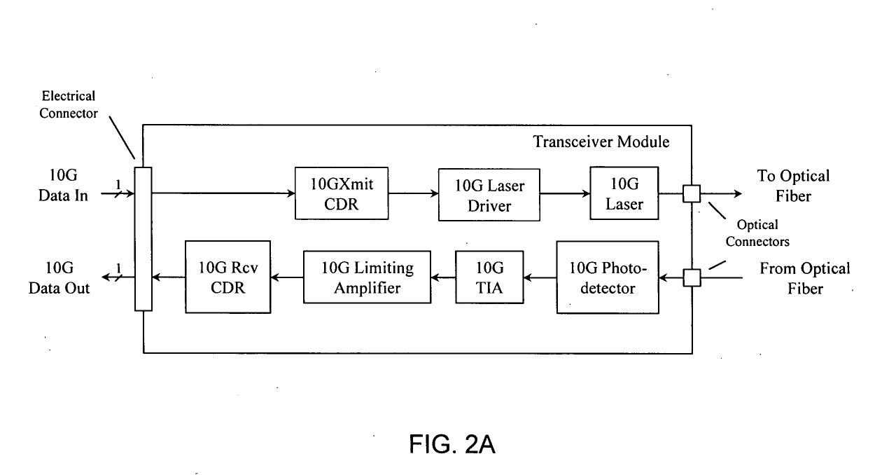

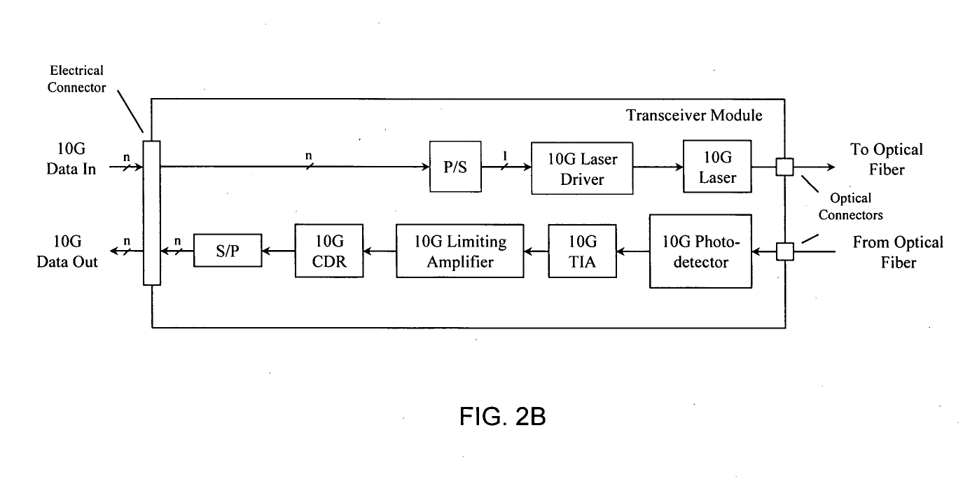

In many applications, the electronic and optical components at each end of the link are housed in a transceiver module, as shown in FIGS. 2A and 2B. In some applications these modules are fixed to a circuit board, and in other applications they are “pluggable” modules that can be inserted into and removed from a cage that is fixed to the circuit card. Multi-Source Agreements (MSAs) have been developed to achieve some degree of interoperability between modules from different manufacturers. FIG. 2A shows a block diagram consistent with the XFP MSA, and FIG. 2B shows a block diagram consistent with the X2, XPAK, and XENPAK MSAs. The 10 Gbps electrical I/O interface for XFP is serial, whereas the 10 Gbps electrical interface is parallel for the other MSAs.

In enterprise networking applications, including local area networks (LANs) and storage area networks (SANs), the installed base of optical fiber is predominantly multimode fiber (MMF). The reason for this is that to date, multimode fiber has supported the distances required for most enterprise applications, and the transceivers for MMF are considerably less expensive than the corresponding transceivers for single mode fiber (SMF), which is predominantly used in telecom metropolitan and long distance applications.

There has been a trend in optical networking to go to ever-increasing data rates. While 100 Mbps was once considered extremely fast for enterprise networking, attention has recently shifted to 10 Gbps, 100 times faster. As is known by those of ordinary skill in the art, it is a property of optical fiber that the distance that a given type of fiber can support decreases as the data rate increases. This is due to fiber dispersion, which causes optical pulses to “smear” as they propagate down the fiber, resulting in intersymbol interference (ISI) at the receiver.

At slower networking speeds, the installed base of MMF was sufficient to support distances of interest for enterprise applications. However, at 10 Gbps, the distances supported by the embedded MMF using traditional serial optical signaling are significantly shorter.

To illustrate the reduction in achievable distance at 10 Gbps, consider two popular standards for enterprise networking, Fibre Channel and Ethernet. Fibre Channel is commonly used for SAN applications, and Ethernet is commonly used for LAN applications. 1 G, 2 G, and 4 G Fibre Channel are specified in Information technology—Fibre Channel—Physical Interfaces—2 (FC-PI-2), Document Number: ANSI/INCITS 404 DRAFT, InterNational Committee for Information Technology Standards (formerly NCITS), 05-Nov.-2004 (abbreviated herein as FC-PI-2). 10 G Fibre Channel is specified in Information Technology—Fibre Channel 10 Gigabit (10 GFC), Document Number: ANSI/INCITS 364, InterNational Committee for Information Technology Standards (formerly NCITS), 06-Nov.-2003. 1 G Ethernet over optical fiber is specified in Clause 38 of IEEE Std 802.3-2002 Carrier Sense Multiple Access with Collision Detection (CSMA/CD) Access Method and Physical Layer Specifications (abbreviated herein as 802.3-2002). 10 G Ethernet is specified in IEEE Std 802.3ae-2002 Media Access Control (MAC) Parameters, Physical Layers, and Management Parameters for 10 Gb/s Operation (abbreviated herein as 802.3ae-2002).

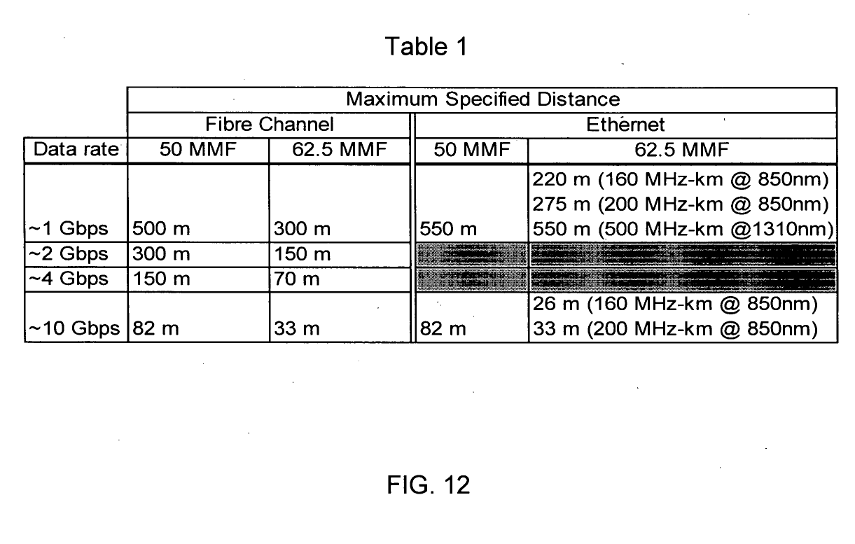

Table 1, given in FIG. 12, shows the maximum specified distances supported by serial optical signaling over MMF at different speeds for Fibre Channel and Ethernet. In Table 1, 50 MMF means MMF with a 50 micron diameter core and a minimum over-filled launch modal bandwidth of 500 MHz-km at a nominal wavelength of 850 nm or 1310 nm, as specified in the Fibre Channel and Ethernet standards. 62.5 MMF means MMF with a 62.5 micron diameter core and a minimum over-filled launch modal bandwidth of either 160 or 200 MHz-km at a nominal wavelength of 850 nm, and 500 MHz-km at a nominal wavelength of 1310 nm, as specified in the Fibre Channel and Ethernet standards. The fiber types included in Table 1 are widely deployed, and they shall be referred to herein as legacy MMF or embedded MMF. Table 1 excludes newer enhanced MMF with a minimum modal bandwidth of 2000 MHz-km. This newer fiber is not as widely deployed as the fibers listed in Table 1, and is dealt with separately below.

Table 1 shows that at 10 Gbps, the distances supported by commonly installed MMF using serial signaling are significantly shorter than those supported at, for example, 1 Gbps. For example, on 62.5 micron fiber with a modal bandwidth at 850 nm of 160 MHz-km, the maximum distance for serial signaling supported by the Ethernet standard is 26 m. (This same fiber has a bandwidth of 500 MHz-km at a 1310 nm wavelength, but the standard does not support 10 Gbps serial signaling at that wavelength on this fiber type.) This presents a problem for an operator of an enterprise network as he looks to increase data rates to 10 Gbps. If, for example, he desires to reach a distance of 300 m, the installed fiber cannot support that distance. 300 m is a commonly required distance for enterprise network structured cabling.

The drafters of the Ethernet and Fibre Channel networking standards realized this problem and proposed three possible solutions. One solution, known as LX-4 in the Ethernet standard, achieves 300 m over embedded MMF by dividing the 10 Gbps data stream into four slower 2.5 Gbps (3.125 Gbps line rate with overhead) data streams and transmitting each over a separate wavelength in a coarse wavelength division multiplexing (CWDM) system. However, this solution has never gained commercial acceptance, because the cost of the CWDM optics and the requirement for four sets of optics at each end of the link have made this solution economically infeasible. Also, CWDM cannot be packaged as compactly as a serial solution due to the use of multiple optical devices at both ends of the link.

The two other solutions contemplated by the drafters of the standards involved replacing the embedded fiber with wider bandwidth fiber. One solution requires replacing the embedded MMF with a newer type of MMF that has an enhanced modal bandwidth of 2000 MHz-km, enabling 300 m distances at 10 Gbps. The other solution requires replacing the embedded MMF with single mode fiber (SMF), which inherently has much lower dispersion than MMF and can therefore support much longer distances. The problem with both of these solutions is that fiber replacement can be very expensive. In addition to the cost of the fiber itself, which is not inconsequential, the cost of labor to replace the fiber can be prohibitive—this is especially true when the fiber resides inside of walls running between different floors of a building, a common installation for Ethernet. The SMF solution also requires special transceivers that connect to SMF—these transceivers are significantly more expensive than MMF transceivers.

There is an additional barrier to widespread adoption of 10 Gbps enterprise networking besides the ability to reach 300 m on embedded MMF. 10 Gbps transceivers, even those designed for MMF, tend to be prohibitively expensive. In contrast to the high cost of 10 Gbps transceivers, 1 Gbps, 2 Gbps, and 2.5 Gbps (abbreviated 1 G, 2 G, and 2.5 G, respectively) transceivers are much less expensive. 1 G transceivers are used in 1 G Ethernet and 1 G Fibre Channel applications. (The line rates are respectively 1.25 Gbps and 1.0625 Gbps.) 2 G transceivers are used in 2 G Fibre Channel applications (the line rate is 2.125 Gbps). 2.5 G transceivers are used in SONET OC-48 applications (the line rate is 2.48832 Gbps). 4 G Fibre Channel (line rate of 4.25 Gbps) is an emerging standard, with projected transceiver costs only slightly more than that of 2 G transceivers.

The low cost of transceivers at these lower speeds was enabled by the advent of low-cost lower speed components: lasers, laser drivers, photodetectors, and transimpedance amplifiers (TIAs). Several technical challenges have prevented similar cost reduction in 10 Gbps components. These challenges are inherent in the high speeds required by these devices, including challenges in packaging and design to avoid electromagnetic interference and electromagnetic susceptibility, and to ensure signal integrity. Also, the nascent market for 10 Gbps networking has not supported the cost reduction seen at 1 Gbps and 2 Gbps that naturally results from economies of scale associated with large volume deployment. In addition to inexpensive 1 G and 2 G electronic and optoelectronic components, inexpensive 4 G components coming on the market to support the emerging 4 G Fibre Channel standard can be used in the present invention.

The present disclosure invention provides a low-cost extended reach optical fiber link capable of reaching at least 300 m on embedded MMF, while providing significant cost reduction over existing 10 Gbps transceiver solutions. The system of this disclosure achieves significant cost reduction by realizing a 10 Gbps transceiver using lower performance optical and electronic components that are available at much lower cost than corresponding 10 Gbps components. Equalization is used to compensate for the distortion introduced by these components, as well as distortion that may be introduced by transport over the MMF.

It is to be understood that the present invention can be used to reduce cost of 10 Gbps transceivers without necessarily increasing the distance transmitted. For example, the invention can be used to reduce cost of transceivers at both ends of a 300 m link of newer MMF with an enhanced modal bandwidth of 2000 MHz-km. In this case the invention is not needed to increase achievable transmission distance, but it does provide the benefit of reduced cost transceivers.

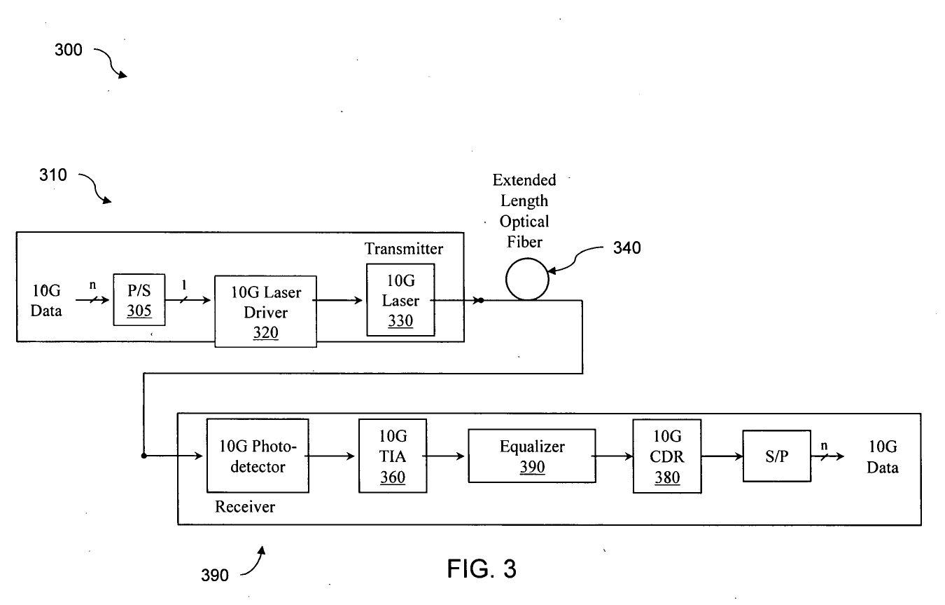

FIG. 3 shows an optical link 300 with receiver equalization to increase achievable distance. The transmitter 310 includes a serializer 305 feeding a 10 G laser driver 320 driving a 10 G laser 330 for launching an optical signal into fiber 340. The transmitter in FIG. 3 is identical to the transmitter in FIG. 1 for a link without equalization. The receiver 390 of FIG. 3 includes an equalizer 370 disposed between a 10 G TIA 360 and a 10 G CDR 380.

The transmitter shown in FIG. 3, which shall be referred to as a conventional 10 G transmitter, is designed to give a very “clean” or undistorted optical waveform at the output of the transmitter. The quality of this signal can be measured by an eye mask test, such as that specified in Clause 52.9.7 of 802.3ae-2002, or by a transmitter and dispersion penalty (TDP) test, such as that specified in Clause 52.9.10 of 802.3ae-2002. To satisfy the requirements of these tests, transceiver manufacturers generally strive to have 20%-80% rise and fall times of the transmitter output optical waveform that do not exceed ½ of a bit period. Another consequence of the transmit waveform quality requirement is that the resonance frequency of the 10 G laser 320 must generally be at a frequency greater than ¾ of the line rate. For a 10 Gbps line rate, the above requirements mean that the rise and fall times must not exceed 50 psec, and the resonance frequency of the laser must be above 7.5 GHz.

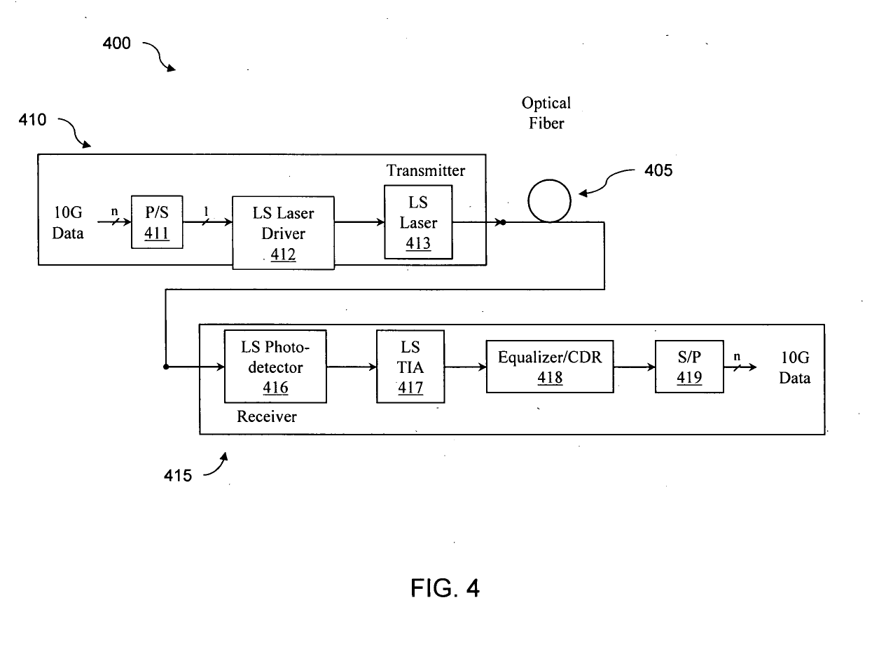

FIG. 4 is a conceptual block diagram of an optical fiber link 400 configured in accordance with the teachings of this disclosure. In contrast to the link shown in FIG. 3, the link in FIG. 4 uses low-speed (designated LS) components in place of 10 G components. The use of these low-speed components will degrade the transmitted waveform compared to the waveform transmitted by the conventional 10 G transmitter of FIG. 3. However, the equalizer present in the receiver 415 compensates for this degradation, thereby enabling the use of these lower cost low-speed components. The fiber length in FIG. 4 may optionally be an extended fiber length, as shown in FIG. 3. FIG. 4 illustrates an exemplary embodiment utilizing a receive equalizer to enable the use of low-speed components and also to optionally extend the distance of 10 Gbps over MMF.

The link 400 of FIG. 4 includes a transmitter 410 configured to receive electrical 10 G data from a data source, convert the electrical data to optical data, and launch the optical data onto a fiber link. Thus, the circuitry of the transmitter 410 may be described generally as an electrical-optical converter. One exemplary embodiment will now be disclosed, though it is contemplated that a wide variety of electrical-optical conversion methods may be employed in the present disclosure.

In one disclosed embodiment, a parallel-to-serial converter 411 may be included to reduce parallel data to a serial stream. When a serial interface is presented by the data source, the converter 411 is not required. The output of converter 411 is coupled to a laser driver 412. In a preferred embodiment, the laser driver 412 is a low-speed (LS) driver, meaning it is compatible with a data rate lower than the data rate of the overall link. For example, in the 10 G system of FIG. 4, the laser driver may comprise a driver initially designed for a data rate lower than the system rate, such as a 2 G, 2.5 G or 4 G rate. In such an embodiment, one would normally use a linear laser driver with a bandwidth less than that required for 10 Gbps. The bandwidth required to support 10 Gbps is not uniquely defined, but a good rule of thumb is that the 3-dB electrical bandwidth of the laser driver should be at least ¾ of the data rate, or 7.5 GHz, for a link without equalization. The low-speed laser driver 412 can have a bandwidth significantly less than 7.5 GHz for a 10 Gbps link when the receiver includes an equalizer in accordance with this invention. For example, a linear laser driver with a bandwidth of 4 GHz might be used. Alternatively, one could use a standard 10 Gbps nonlinear laser driver that performs limiting on the incoming waveform. When a low-speed laser driver is used, the use of a linear laser driver avoids the introduction of nonlinearities that the equalizer would have difficulty compensating.

A low-speed laser source 413 is coupled to the driver 412, and is likewise a laser source designed for a lower data rate than the system data rate. The speed of a laser is often defined in terms of its 20%-80% rise and fall times, and by its relaxation oscillation frequency at its steady-state “on” power level. A link without equalization would normally require use of a laser that has 20%-80% rise and fall times not exceeding ½ bit period. For example, at 10 Gbps both the rise time and fall time usually would not exceed 50 psec. In contrast, the presently described invention can use a low-speed laser source with rise and fall times that exceed ½ bit period for the line rate of interest, or 50 psec for a 10 Gbps link.

Another differentiating characteristic between a low-speed laser and a high-speed laser is the relaxation frequency of the laser at the normal “on” power level. The relaxation frequency is the frequency of relaxation oscillations, a characteristic well known to those of ordinary skill in the art. Normally the relaxation frequency must be above ¾ of the line rate for a link without equalization. For a link with equalization, the relaxation oscillations can be filtered out either by the filtering effects of an extended length of fiber, by the filtering effects of a low-speed receiver, or by the optimal filtering effects of the equalizer itself. Since the equalizer can mitigate the distortion caused by filtering, the relaxation oscillations can be filtered out without undue degradation of system performance. The low-speed laser source 413 may therefore have a relaxation frequency less than ¾ of the line rate; i.e., at 10 Gbps, the low-speed laser source can have a relaxation frequency of less than 7.5 GHz.

The operating wavelength of the laser is chosen to achieve a desired modal bandwidth of the fiber. The distance desired and the type of fiber will influence the choice of wavelength. For example, consider the embedded fibers shown in Table 1. To achieve 300 m on 62.5 micron fiber, one would select a nominal operating wavelength of 1310 nm to realize a modal bandwidth of 500 MHz-km. If a distance of 100 m is desired, for example for data center applications, a nominal wavelength of 850 nm could be used with 62.5 micron fiber. The resulting modal bandwidth would be either 160 MHz-km or 200 MHz-km, depending on the particular type of fiber. The 50 micron fiber shown in Table 1 provides a modal bandwidth of 500 MHz-km at either 850 nm or 1310 nm, so either wavelength could be used to achieve 300 m The modal bandwidth required to achieve a particular distance can be determined through computer modeling techniques, described below.

The output of the laser 413 is launched on a length of optical fiber 405. In preferred embodiments, the length of fiber 405 may exceed 26 m to specifically include 220 m, 275 m, and 300 m. 220 m and 275 m are important because they are standard distances currently supported at 1 Gbps by 1000BASE-SX Gigabit Ethernet, which is widely deployed.

The system 400 includes a receiver 415 coupled to the fiber 405. The receiver is preferably configured to receive optical data and convert the optical data to electrical data, and provide the converted data to a desired destination. Thus, the receiver 415 may be described generally as an optical-to-electrical converter. The receiver 415 includes a photodetector 416 configured to receive data from the fiber 405, and pass detected data to a transimpedance amplifier (TIA) 417. The photodetector 416 and/or TIA 417 may each comprise a low-speed component substantially similar to one designed to operate at a lower data rate than that of the system. As used herein, the functionality performed by the photodetector 416 and TIA 417 may be generally referred to as an optical front-end converter. Thus, the receiver 415 may be generally described as including an optical-to-electrical front end converter coupled to an equalizer/CDR.

A conventional 10 G receiver would normally use an optical-to-electrical front-end converter with a small-signal 3-dB electrical bandwidth no less than 70% of the line rate, or 7 GHz. In terms of 20%-80% rise and fall times, a conventional 10 G receiver would normally use an optical-to-electrical front end converter with rise and fall times no greater than ½ of the bit period, or 50 psec at 10 Gbps. These limits on bandwidth and rise/fall times are not absolute. The bandwidth could be decreased and the rise times could be increased somewhat by trading off receiver sensitivity.

The low-speed optical-to-electrical front end converter, on the other hand, could have a 3-dB electrical bandwidth substantially less than 7.5 GHz, for example, 1.5 GHz or 4 GHz. In terms of rise/fall times, the low-speed optical-to-electrical front end could have rise and fall times exceeding 50 psec. The equalizer that follows the optical front end minimizes any degradation resulting from the reduced bandwidth or increased rise/fall times. As will be described more fully below, sensitivity of the receiver is actually improved by using a low-speed PIN/TIA combination in conjunction with receiver equalization.

The output of TIA 417 is coupled to equalizer 418, where the data is equalized and clock and data recovery functions may be performed, as will be more fully described below. The output of receiver 415 may then optionally be converted to a desired parallel form in serial-to-parallel converter 418. 10 G data may then be presented to a desired destination. If serial data is desired at the destination, the serial-to-parallel converter 418 is not required.

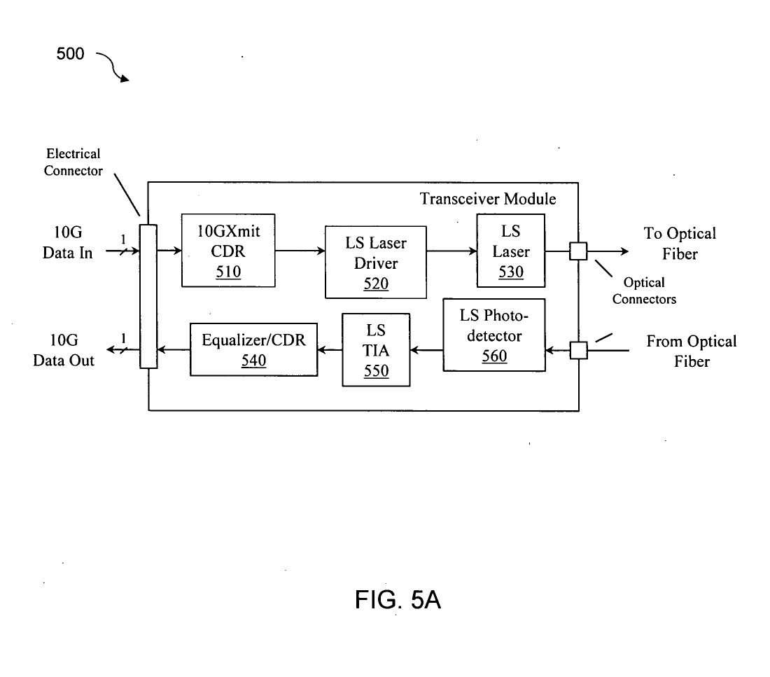

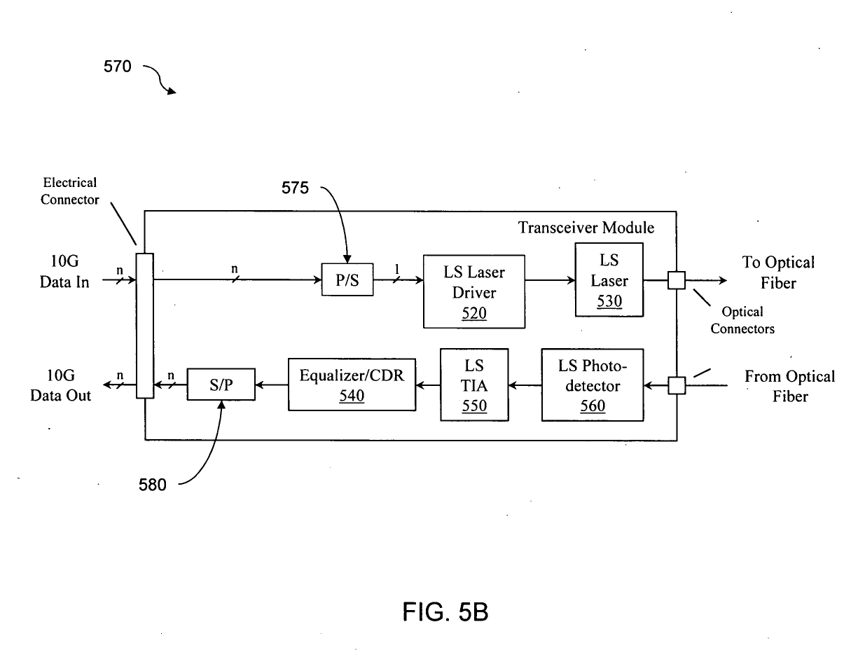

FIGS. 5a and 5b are block diagrams of preferred embodiments that are modularized transceivers for the serial I/O and parallel I/O MSAs, respectively. The transceiver 500 of FIG. 5a includes a transmit module including a multi-pin electrical connector 505 coupled to a clock and data recovery circuit (10 GXmit CDR) 510 coupled to a laser driver 520 configured to drive a laser 530. The CDR 510 is used to clean up any distortions suffered by the serial 10 Gbps electrical data stream that is input to the module. Such distortion can be caused by the electrical path traversed before the signal reaches the module, the connector 505, or the electrical path within the module.

The receive module includes an optical photodetector 560 feeding a TIA 550. The output of the TIA 550 is fed to an equalizer/CDR 540.

As will be appreciated, the receive and transmit functionality is all disposed within a single transceiver unit.

The transceiver 570 of FIG. 5b includes the functionality of transceiver 500, but includes parallel-to-serial converter 575, and serial-to-parallel converter 580 for providing parallel interfaces in accordance with parallel I/O MSAs. The electrical connector 571 for the parallel I/O transceiver will usually have more pins than the electrical connector 505 for the serial I/O transceiver to accommodate the increased number of I/O lines. The transmit CDR 510 is generally not required for this type of MSA due to the lower data rates on each of the parallel lines of the parallel interface.

Though all of the functionality in the converters of FIGS. 4, 5a, and 5b is shown as being low speed components, it is to be understood that one or more of the devices may be substituted with a high speed device as desired. For example, in some situations it may be advantageous to utilize low speed components only in the receiver unit, while using high speed devices in the transmitter.

Embodiments of a decision feedback equalizer suitable for use as the Equalizer/CDR will now be disclosed. The structure and function of a decision feedback equalizer (DFE) are well known by those skilled in the art. For a general discussion of DFEs, see, for example, Gitlin, Hayes, and Weinstein, Data Communications Principles, Plenum Press, 1992, Section 7.5. For a discussion of high-speed equalization for optical fiber communication, including high-speed architectures and implementations, see Winters and Gitlin, “Electrical Signal Processing Techniques for Fiber Optic Communication Systems,” IEEE Trans. on Communications, September 1990.

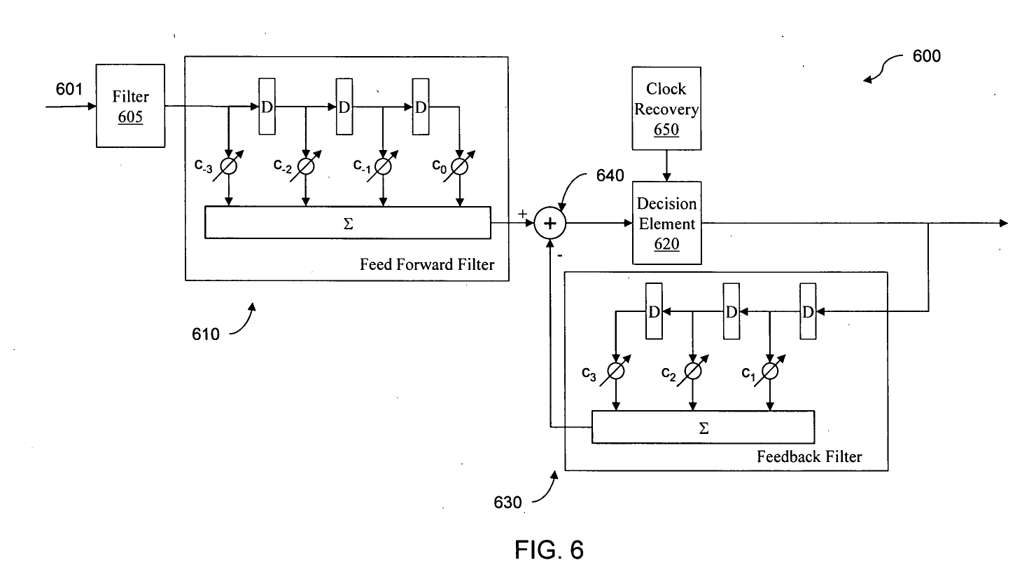

FIG. 6 shows one exemplary configuration of a DFE 600 suitable for use in the present disclosure. FIG. 6 shows one possible implementation of the DFE, though several other implementations are well-known. In particular, other architectures have been proposed to meet the high speeds required for optical fiber communications.

The DFE consists of a band-limiting filter 605, a feed forward filter 610, a decision element 620, a feedback filter 630, and a summing element 640 coupled between the feed forward filter 610, the feedback filter 630, and the decision element 620.

A signal 601 received from the channel is fed into a band-limiting filter 605, which in turn presents the signal to the feed forward filter 610. For fiber optic communications, the received signal would typically come from the transimpedance amplifier (TIA) shown in FIGS. 3, 4, and 5. The feed forward filter 610 is preferably configured to form a weighted sum of delayed samples of the signal, with the delay between each sample provided by the delay elements D in FIG. 6. The nominal delay of each delay element is typically a single bit period to form a so-called T-spaced equalizer, or a simple fraction (for example, ½) of a bit period to form a so-called fractionally spaced equalizer.

For a T-spaced equalizer, it is known by those skilled in the art that the optimal bandlimiting filter 605 is a filter matched to the received pulse shape. The filter 605 for a fractionally spaced equalizer need only provide anti-aliasing for the tap spacing of the feed forward filter that follows. For example, consider a fractionally spaced equalizer with a nominal delay of T/2 between taps in the feed forward filter. In this case, the bandlimiting filter 605 could be a simple Butterworth filter with bandwidth exceeding that of the incoming signal up to a maximum of 1/T (nominally 10 GHz for a nominal 10 Gbps system). A fourth-order Butterworth filter with 3-dB bandwidth of 5 GHz would serve as filter 605 when the signal out of TIA 417 is limited to less than 5 GHz.

In practice, the noise out of the optical-to-electrical front end will be bandlimited. In that case the, the filter 605 can be omitted with some degradation in performance. The degradation will be minimal if the tap spacing is less than 1/(2B), where B is the bandwidth of the optical-to-electrical front end.

At low speeds, the feed forward filter of a DFE is often realized digitally. In this case, an analog-to-digital converter would be interposed between the bandlimiting filter 605 and the feed forward filter 610. At the high speeds required by fiber optic communications, the feed forward filter is usually implemented as an analog tapped delay line. The weights in the weighted sum are indicated by coefficients cₙ where—(N_{f}−1)≦n≦0. N_{f} is the number of feed forward taps. In the current example, N_{f} is 4, but N_{f} may be any positive integer.

The output of the feed forward filter 610 is fed to the summing element 640. The other input to the summing element is fed by the output of the feedback filter 630.

The decision element 620 receives the signal from the summing element 640 and decides which symbol was sent during each symbol period. For the binary on-off keyed signaling common in optical fiber applications, the decision element 620 may comprise a conventional binary slicer that decides if the signal is above or below a given threshold at the decision instant, which occurs once per symbol period (or bit period, for binary signaling). The timing of the decision instant is controlled by the clock recovery circuit 650. The clock recovery circuit recovers timing from the incoming signal according to any one of several well-known methods. While the clock recovery circuit is shown in FIG. 6, the clock recovery circuit is not usually considered part of a DFE.

The bits recovered by the decision circuit 620 are output to the remainder of the receive chain. This is the output of the Equalizer/CDR in FIGS. 4 and 5. The recovered bits are also fed back to the summing element 640 via the feedback filter 630 shown in FIG. 6.

The feedback filter 630 forms a weighted sum of the recovered bits. The recovered bits are fed into a tapped delay line with each delay element providing a nominal delay of one bit period. The weights in the weighted sum are given by the coefficients cₙ where 1≦n≦N_{b}. The integer N_{b} is the number of feedback taps. N_{b} can be any positive integer—it is equal to 3 in the example DFE shown. The output of the feedback filter 630 is subtracted from the output of the feed forward filter by the summing element 640.

The coefficients cₙ in both the feedback and feed forward filter can be made adaptive using well-known adaptation algorithms. This allows the equalizer to adapt to the characteristics of a particular fiber or set of transmit and receive components. The coefficients may be adapted to optimize a predetermined criterion. One such criterion is the “zero-forcing” criterion, which seeks to eliminate ISI as much as possible without regard to how this might enhance the noise entering the decision element.

Another optimization criterion is the “mean-squared error” (MSE) criterion, which seeks to minimize the mean squared error between the signal entering the decision element at the sampling instant and the actual level that was transmitted.

The purpose of the feed forward filter 610 in the DFE is to reduce or eliminate the intersymbol interference (ISI) that results from those bits that are transmitted after the “current bit”, that is, the bit that is currently being decided by the decision circuit. The purpose of the feedback filter 630 is to reduce or eliminate the intersymbol interference resulting from those bits that were transmitted before the current bit. Note that the feedback filter processes bits that have already been decided, whereas the feed forward filter processes channel outputs corresponding to bits that have not yet been decided.

There are other types of equalization that are suitable for use in the present disclosure. The feed forward equalizer (FFE) is an example of one. The architecture of the FFE is identical to the filter 605 followed by the feed forward filter 610 of the DFE. The FFE can be considered to be independent of the clock and data recovery (CDR) circuit. This configuration is reflected in FIG. 3, which shows the equalizer feeding an independent CDR.

As mentioned above, an FFE, or the feed forward filter of the DFE, is usually implemented as an analog tapped delay line for high speed optical fiber communications. See, for example, B. L. Kasper, et al, “An APD/FET optical receiver operating at 8 Gbit/s,” J. Lightwave Technol., vol. LT-5, pp. 344-347, March 1987, and H. Wu, et al, “Differential 4-tap and 7-tap transverse filters in SiGe for 10 Gb/s multimode fiber optic link equalization,” Solid-State Circuits Conference, 2003. Digest of Technical Papers. ISSCC. 2003 IEEE International, 9-13 Feb. 2003, vol. 1.

The feedback filter can also be implemented by an analog tapped delay line. Note, however, that latency is a bigger issue for the feedback filter than it is for the feed forward filter. That is because an input to the feedback filter must propagate from the output of the decision element through the filter and the summing element to the input of the decision element within a single bit period. One way to address this speed requirement is to use very high-speed circuitry, such as that achievable with SiGe technology. Another method is to attack the bottleneck by changes in architecture. See, for example, S. Kasturia and J. Winters, “Techniques for High-Speed Implementation of Nonlinear Cancellation,” IEEE Journal on Selected Areas of Communications, Vol. 9. pp. 711-717, June 1991, for a method that changes the architecture to reduce the raw speed requirements of the underlying technology.

While the equalizer referred to above has been described as an FFE or a DFE, it will be understood by those skilled in the art that an equalizer is not limited to these types of structures. There are several known methods of equalization which may be employed in the current invention. These include, for example, Maximum Likelihood Sequence Detection (MLSD), Finite Delay Tree Search (FDTS), and others. Any method or device that effectively deals with the ISI introduced by the use of the low-speed components is understood to be included by the term “equalizer” as used in this disclosure.

The effectiveness of the present disclosure may be demonstrated through computer modeling. The results of this modeling explicitly demonstrate specific performance advantages of the disclosed invention. The performance of the DFE for a linear channel can be predicted based on the transmitted pulse shape, the transmitted signal power, the attenuation of the channel, the impulse response of the channel, and the noise power spectral density (PSD) at the receiver. All of these quantities can be calculated based on characteristics of the devices that comprise the optical fiber communication channel.

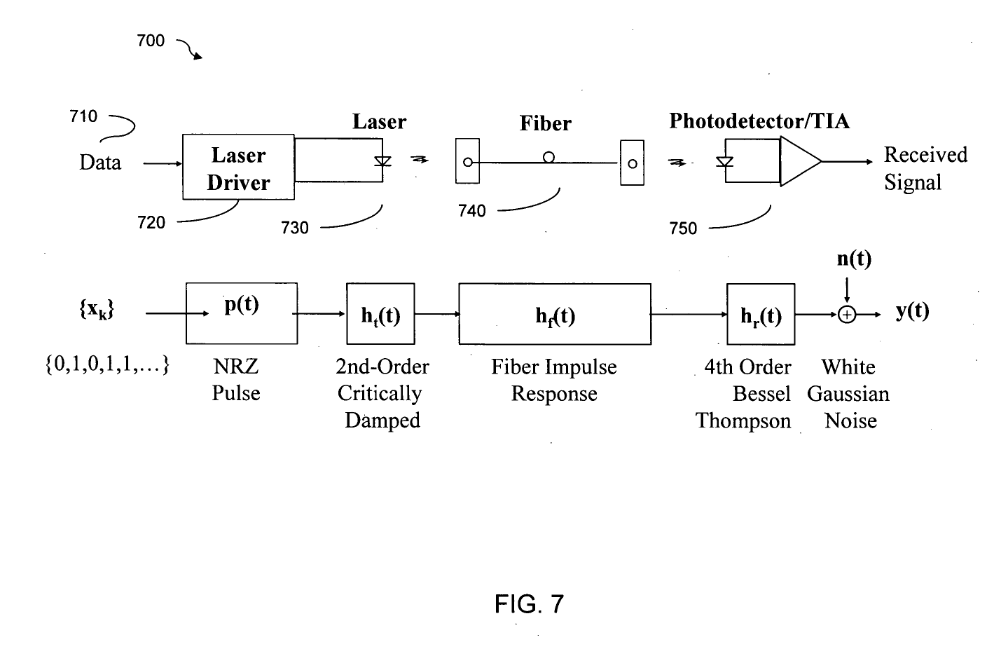

FIG. 7 shows one exemplary model 700 representing a fiber channel. FIG. 7 shows the essential elements of a fiber channel shown above their corresponding models. The performance of an MMF optical fiber transmission with low-speed components may be calculated using the model shown in FIG. 7.

The data pulses 710 transmitted are non-return-to-zero (NRZ) pulses that are filtered by the laser driver and the laser. (Four-level pulse amplitude modulation (PAM-4) is considered further on.) The laser driver may be a limiting nonlinear device, in which case a high-speed (10 Gbps) laser driver is used. In that case, the output of the laser driver approximates 10 Gbps NRZ pulses. In another embodiment, a linear laser driver is used. In that case, the laser driver is a linear wideband amplifier that may have bandwidth significantly less than 10 GHz. For example, a bandwidth of 3 or 4 GHz can be used. The choice of a high-speed nonlinear laser driver or a lower bandwidth linear laser driver will be made on cost and other design considerations.

The laser 730 is directly modulated by the current from the laser driver 720. The laser 730 is modeled as a linear device with optical output power that is a filtered version of the drive current provided by the laser driver. The filter is modeled as a second order critically damped filter. This is a well-accepted model for the types of lasers and typical operating conditions used for MMF optical fiber communications. The transfer function of the laser is given by
H(s)=(2πfₙ)²/(s+2_{πf}ₙ)²
where
s=j 2πf
fₙ=frequency (Hz)
   fₙ is related to the speed of the laser through the 20-80% rise time Tᵣ by fₙ=0.345/Tᵣ. For a 10 G laser, Tᵣ is modeled as 47.1 psec, consistent with requirements of the IEEE 10 GBASE-LR standard. For a 4 G laser, Tᵣ is modeled as 90 psec, consistent with requirements of the 4 G Fibre Channel standard. For a 2 G laser, Tᵣ is modeled as 160 psec.

It is well known that laser optical output is governed by nonlinear laser rate equations. This may call into question whether the linear model of the laser is sufficient. However, in the bandwidth of interest, the laser can be approximated as being linear. In other words, the nonlinear phenomena, such as relaxation oscillations, are at high frequencies that are filtered out either by the low bandwidth of the fiber or by a low-speed receiver filter. Alternatively, a lowpass filter can be interposed between the laser driver and the laser to further suppress nonlinear oscillations in the laser optical output.

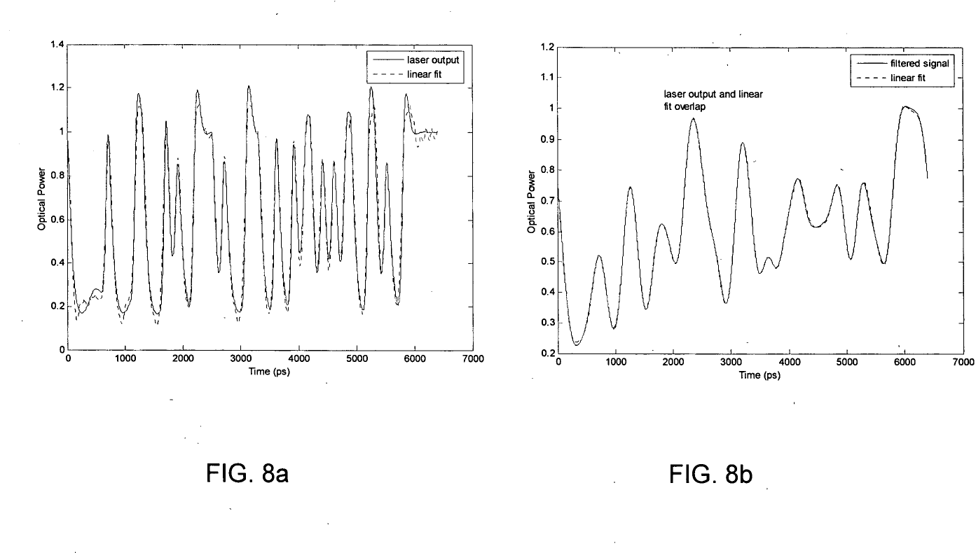

A simulation demonstrates that the laser can be accurately modeled as a linear device when the laser output is filtered. Referring briefly to FIG. 8a, a plot shows the modeled output of a laser with approximately 4-GHz 3-dB electrical bandwidth modulated by a 10 Gbps NRZ pulse stream, as predicted using the nonlinear laser rate equations mentioned above. Also shown in FIG. 8a is the best linear fit of the output waveform to the input data stream. That is, the output waveform is expressed as a linear superposition of pulses, where a pulse is sent if the corresponding data bit is a “1”, and no pulse is sent if the corresponding data bit is a “0”. While the agreement in parts of the two curves is good, the linear fit does not match the overshoots when the waveform transitions from low to high. Also, the troughs do not match well when the waveform transitions from high to low, and the match is not good for several “1”s in a row.

FIG. 8b shows the results when the output of the laser is filtered by a Gaussian filter with 3 dB optical bandwidth equal to 1.67 GHz. This corresponds to a MMF of length 300 m if the fiber has a Gaussian impulse response with modal bandwidth of 500 MHz-km. In FIG. 8b, the filtered version of the output determined by the laser rate equations matches the best linear fit very closely, showing that the linear approximation of the laser is a good one when the bandwidth of interest is restricted.

The fiber 740 is modeled as having a Gaussian impulse response with a given bandwidth. The fiber modal bandwidth is assumed to be 500 MHz-km at the wavelength of operation. This is consistent with the overfilled-launch bandwidth of 500 MHz-km for legacy 50 micron fiber at a nominal wavelength of either 850 nm or 1310 nm and legacy 62.5 micron fiber at a nominal wavelength of 1310 nm. These are the types of MMF reflected in Table 1. The principles of this invention can be applied to MMF channels with other modal bandwidths, including 400 MHz-km and 2000 MHz-km, with adjustments in achievable distance.

To get the actual bandwidth for a given length of fiber, one divides the modal bandwidth by the length of the fiber. A 300 m length of fiber with modal bandwidth of 500 MHz-km has a bandwidth of 500 MHz-km/0.3 km=1.67 GHz.

Actual multimode fiber exhibits a variety of impulse responses. The IEEE studied a number of fibers and published the corresponding impulse responses during development of the 1 Gbps Ethernet standard. Among impulse responses of a given bandwidth, the Gaussian response represents a particularly challenging response, so this disclosure will analyze performance using this model of the fiber impulse response. The analysis can easily be performed on other impulse responses, showing similar or better results.

As an example of alternative models for the impulse response of the multimode fiber 740, the University of Cambridge in England has developed a statistical model (described herein as “Cambridge Model”) that comprises a set of impulse responses. For a description of this model, see the following reference: M. Webster, L. Raddatz, I. H. White, D. G. Cunningham, “A statistical analysis of conditioned launch for Gigabit Ethernet links using multimode fiber,” Journal of Lightwave Technology, vol. 17, no. 9, pp. 1532-1541, 1999. The IEEE 802.3aq Task Force, which is developing a standard for 10-Gbit/s transmission over multimode fiber, is using the Cambridge Model (specifically for the case of 1310 nm laser wavelength and 62.5 micron fiber) as part of its work. See, for example, http://grouper.ieee.org/groups/802/3/aq/public/may04/cam_{—}1_{—}0504.pdf. The set of impulse responses used by the IEEE is meant to represent (in a statistical sense) the worst 5% of installed fibers. Substituting this set for the Gaussian impulse response in block 740 enables analysis of the performance of low-speed optical components on the Cambridge Model.

The spectral shaping of the Photodetector/TIA combination 750 is modeled as a fourth order Bessel Thompson filter. Receiver noise is modeled as the addition of white Gaussian noise after the Bessel Thompson filter. The noise power spectral density is computed from the bandwidth of a given Photodetector/TIA and the specified sensitivity of the Photodetector/TIA, which is the optical power required to achieve a given bit error rate. Knowing the sensitivity and specified bit error rate, one can compute the variance of the Gaussian noise. Knowing the bandwidth of the Photodetector/TIA, one can then compute the power spectral density of the white Gaussian noise. Alternatively, one can compute the noise power spectral density directly if the variance of the noise and the noise bandwidth are specified.

The formula for computing S(f), the two-sided power spectral density of the white noise, is given by
S(f)=σ²/2Bₙ
where
σ²=noise equivalent power, referred to the optical domain
Bₙ=Noise equivalent bandwidth in GHz

If the noise equivalent bandwidth is not specified, it can be approximated by the 3-dB electrical bandwidth of the photodetector/TIA. The rms noise, referred to the optical domain, is given by
σ=S_{OMA}/2Q₀
where
S_{OMA}=Sensitivity in optical modulation amplitude (OMA), measured in mW
Q₀=7.03 for a target bit error rate of 10⁻¹²
   Hence
   S(f)=S_{OMA}²/(8Q₀²Bₙ).
   Since we are interested in characterizing the noise, and ISI is treated elsewhere, we use the S_{OMA} excluding any eye closure penalty. If the transceiver operates at multiple rates, this usually means using the S_{OMA} specified for the lowest rate, where eye closure is minimal. If the sensitivity of the device is not given in OMA, but is instead specified by an average received power S_{AVE} and an extinction ratio β, S_{OMA} can be computed using the well-known formula
   S_{OMA}=2 S_{AVE}(β−1)/(β+1)
   S(f) is referred to the optical domain, hence its units are mW²/GHz.

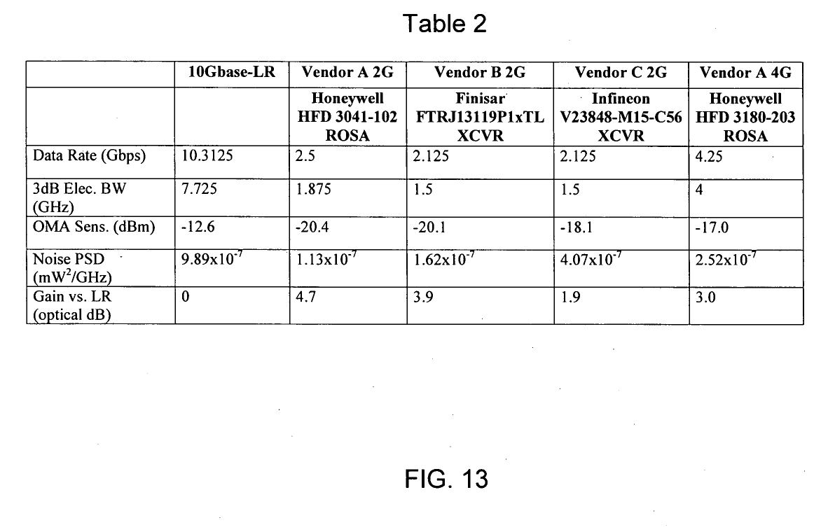

For a specific numerical example, refer to the Vendor B 2 G column of Table 2, given in FIG. 13. The specified sensitivity in average optical power, S_{AVE}, for this device is −22 dBm at an extinction ratio of 9 dB. This corresponds to an OMA sensitivity, S_{OMA}, of −20.1 dBm. Using the formula above and the specified electrical 3-dB bandwidth of 1.5 GHz, this corresponds to a noise PSD, referred to the optical domain, of 1.6e-7 mW²/GHz.

The Photodetector/TIA combination is commonly packaged together as a receive optical subassembly (ROSA). This is a particular packaging of the optical-to-electrical front-end converter described earlier. Table 2, given in FIG. 13, shows a table presenting the computed power spectral density for various commercially available Photodetector/TIA combinations. The 10 GBASE-LR column is based on parameters of the 10 GBASE-LR link budget. Of the other four columns, two of the commercially available products are ROSAs, and two are transceivers that each include a Photodetector/TIA combination. The results show that the lower speed Photodetector/TIAs consistently have lower noise power spectral densities. If not for the additional ISI induced by the low speed Photodetector/TIAs, these components would enable better performance (e.g., longer fiber length) than would the conventional receiver (i.e., one without an equalizer) specifically designed with 10 G components. However, by using the teachings of this disclosure, an equalizer can compensate for the ISI induced by a low-speed Photodetector/TIA, and the lower noise power spectral density of that Photodetector/TIA will result in improved margin over a receiver designed with a 10 Gbps Photodetector/TIA. Hence, the present disclosure not only enables lower cost of a 10 Gbps receiver by using less expensive low-speed components, it also offers improved performance at some fiber lengths. This is seen in the results that follow.

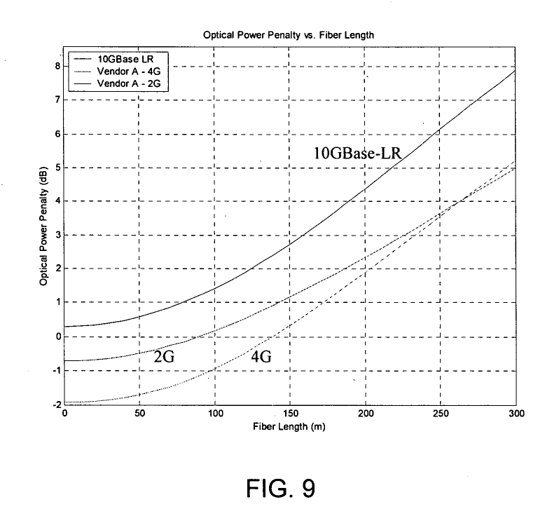

FIG. 9 is a plot showing advantages obtained with the use of low speed receiver components at longer fiber lengths when one uses a DFE in accordance with the teachings of this disclosure. The curves in FIG. 9 are computed using the model of FIG. 7 with a 10 G laser, a receiver with noise power spectral density and electrical 3 dB bandwidth given in Table 2, and an ideal DFE with an infinite number of feed forward and feedback taps. The DFE modeled is a T-spaced equalizer with a filter matched to the received pulse shape as the bandlimiting filter 605. The method to compute performance for such an ideal DFE based on the shape of the channel can be found in a variety of textbooks, such as Section 7.5.2 of Gitlin, Hayes, and Weinstein, Data Communications Principles, 1992. While the infinite length DFE is an idealization, the performance can be approached within a certain implementation penalty by finite length equalizers with a practical number of taps. For the T-spaced equalizer, 10 feed forward taps in feed forward filter 610 and 4 feedback taps in feedback filter 630 give reasonably good performance with respect to the ideal infinite length case. For a fractionally spaced T/2 equalizer, 15 feed forward taps and 4 feedback taps similarly give good performance.

When low-speed receiver components are used, the bandwidth of the received signal is small compared to 1/T, where T is the bit period and is also the tap spacing of the feedforward filter. In this case, the results are not very sensitive to the exact shape of the bandlimiting filter 605, allowing a fixed low pass filter to be used for a wide range of fiber impulse responses. When a 2 G receiver is used, a 5 GHz bandwidth 4^{th} order Butterworth filter can be used as the bandlimiting filter 605.

The power penalty shown in FIG. 9 is with respect to the nominal sensitivity of a 10 GBASE-LR receiver, −12.6 dBm measured in optical modulation amplitude (OMA). This sensitivity is the optical power that would be required by an LR receiver for a 1e-12 bit error rate (BER) if the transmitter and receiver were ISI-free and if the fiber were of negligible length. A penalty of 1 dB at a given fiber length means that an actual receiver would need a received OMA of −11.6 dBm to achieve the specified BER of 1e-12. All curves in FIG. 9 are with a DFE in the receiver. The 10 GBASE LR curve is not for a standard 10 GBASE LR receiver—it is for a 10 GBASE LR type Photodetector/TIA combination (or optical-to-electrical front-end converter) followed by a DFE.

FIG. 9 shows that at a length of 300 m, the noise plus residual ISI for the modified 10 GBASE LR receiver is worse than the noise plus residual ISI for the 10 Gbps receivers built with either a 2 G or 4 G Photodetector/TIA, where residual ISI is the ISI that the DFE cannot compensate. This shows that even though the 2 G and 4 G Photodetector/TIAs generate more ISI than that generated by a 10 G Photodetector/TIA, the equalizer mitigates the ISI, and the lower noise PSD of the low-speed devices results in a net performance advantage at 300 m.

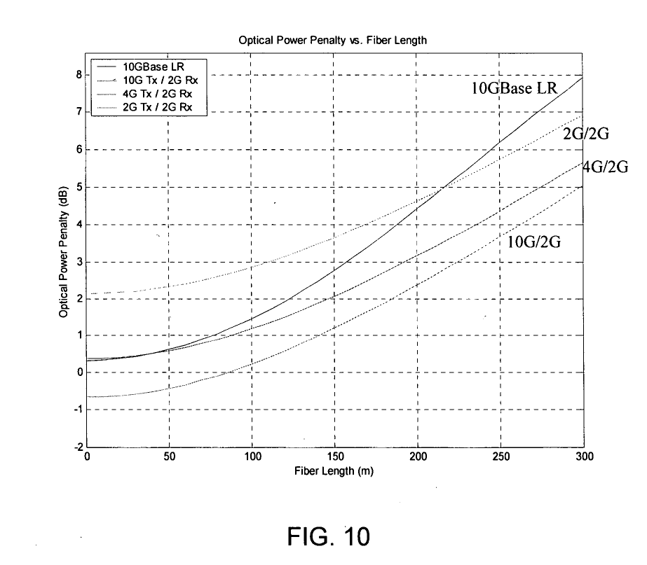

Transceiver cost can be further reduced by using low-speed components in the transmitter part of the transceiver as well. FIG. 10 is a plot comparing the penalty incurred when using high-speed transmit and receive versus low-speed transmit and receive components. The receiver parameters are from Table 2, with the Vendor A data used for the 2 G components. Penalty is with respect to the nominal sensitivity of a 10 GBASE LR transceiver. As in FIG. 9, the 10 GBASE LR curve is not for a standard 10 GBASE LR transceiver—it uses 10 G transmit and receive components, but also includes a DFE in the receiver. The DFE modeled is again an ideal T-spaced, infinite length DFE with a matched filter at the front end. As one would expect, FIG. 10 shows that the penalty increases as the transmitter speed decreases. However, the relative penalty between the high speed transmitter and the low speed transmitters gets smaller as the fiber length increases. That is, at 300 m, a link with 4 G transmit components and 2 G receive components performs almost as well as a link with 10 G transmit components and 2 G receive components. That is because the fiber accounts for a large part of the bandwidth limiting of the overall channel, so the restricted bandwidth of the laser is less important in determining overall system performance. Note also that both links with the low-speed transmit components and 2 G receive components outperform the 10 G transmit./10 G receive (10 Gbase LR) link at 300 m, further demonstrating the advantage of the low-speed receive components when combined with the equalizer.

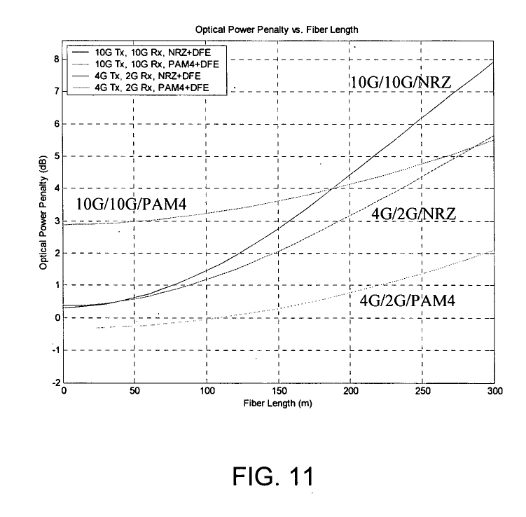

Some measured fiber impulse responses cannot be equalized using NRZ signaling and DFE. If it is desired to transmit 300 m over these fibers, a different modulation scheme is needed. PAM-4 provides an alternative modulation scheme that also enables the use of low-speed components. FIG. 11 is a plot comparing the performance of PAM-4 versus NRZ, implemented with low-speed components and high-speed components, all with DFE in accordance with the teachings of this disclosure. The transmitter, receiver, and DFE parameters are as in the previous descriptions.

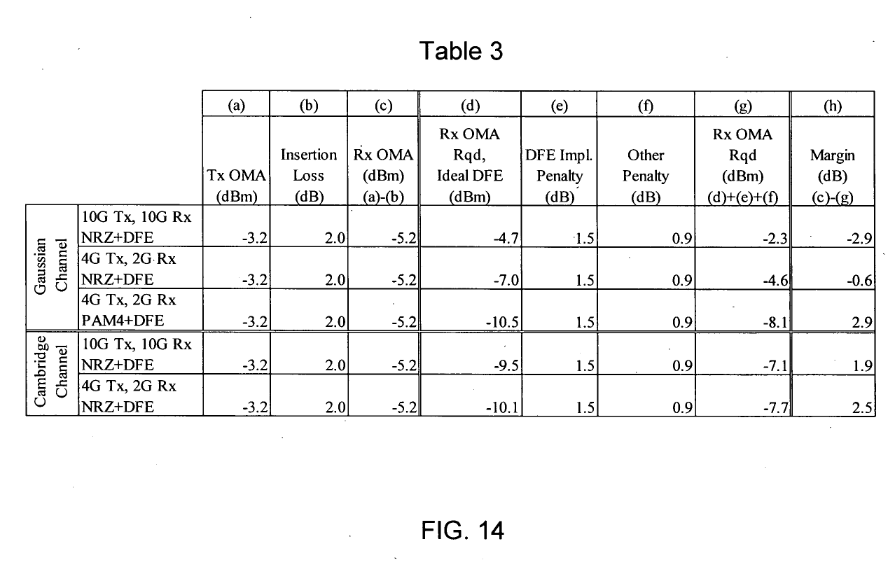

Table 3, given in FIG. 14, summarizes the performance of various link configurations for 300 m transmission. Tx OMA (column (a)) is the optical transmit power, measured in dBm of optical modulation amplitude (OMA) that is launched into the fiber. Insertion loss (column (b)) is the loss of 300 m of optical fiber plus connectors. Rx OMA (column (c)) is the power of the received signal, measured in dBm of OMA. It is obtained by subtracting column (b) from column (a). Rx OMA Rqd, Ideal DFE (column (d)) is the value computed by computer modeling (described above) required to achieve a bit error rate of 1e-12 with an ideal infinite-length DFE. The DFE implementation penalty (column (e)) accounts for performance loss compared to the ideal infinite-length DFE. This implementation penalty accounts for a finite number of taps, finite precision arithmetic, mismatched delays, etc, and should be between 1 dB and 2 dB, depending on the specific design of the equalizer. A 1.5 dB implementation loss is assumed for this link budget. Other Penalty (column(f)) accounts for such effects as modal noise, relative intensity noise (RIN), and mode partition noise (MPN) for a multimode laser. The sum of all of these penalties has been accounted for with a 0.9 dB penalty. Rx OMA Rqd. (column (g)) is the OMA required at the receiver to close the link for the various combinations of modulation and optoelectronic components with a realizable DFE and the penalties given in columns (e) and (f). It is computed as the sum of columns (d), (e), and (f). Margin is the difference in dB between the received OMA (column (c)) and the receive OMA required (column (g)). The margin must be greater than or equal to zero for the link to close.

As one having the benefit of this disclosure will now appreciate, for the NRZ case, the combination of the 4 G components and the 2 G components in conjunction with a DFE performs better than the combination of 10 G transmit and receive components. Thus, the low speed components enjoy performance advantages as well as lower cost. The margin is still negative by 0.6 dB for the transmit power listed and a Gaussian channel. The Gaussian channel with a 500 MHz-km bandwidth is particularly challenging to equalize at a length of 300 m. Many multimode fibers of the same modal bandwidth have impulse responses that are equalized better with a DFE, and these channels can be shown to close using these low-speed components. The 0.6 dB shortfall of the Gaussian channel with NRZ can be overcome through some combination of increasing the transmit power, reducing the noise of the receiver, or reducing the implementation loss of the equalizer, resulting in link closure. Alternatively, PAM-4 with a 4 G components and a 2 G components closes the link for the Gaussian channel under study with a positive margin of 2.9 dB. The improved margin is obtained at the expense of the added complexity of PAM-4 over NRZ.

Table 3 also includes simulated results for the performance of link configurations using the Cambridge Model to represent the fiber impulse response. These results use “Version 2.1” of the Cambridge Model, which consists of a set of 108 fibers. Each fiber is simulated for offsets (the relative distance between the center of the fiber and the center of the beam coming out of the laser) of 17, 20 and 23 microns. Therefore a total of 324 impulse responses are simulated. Rx OMA Rqd, Ideal DFE (column (d)) is computed such that 80% of the impulse responses in this set have a BER of 1e-12 or better. Therefore, under the assumption that the Cambridge Model represents the worst 5% of installed fiber, 99% of impulse responses of installed fiber will have a BER of 1e-12 or better with an ideal DFE at the receive OMA shown. Looking at column h, 99% of installed fibers will have a positive margin of 1.9 dB for 10 G transmit and receive components, and 2.5 dB for 4 G transmit 2 G receive components. Again, the lower cost low-speed components, when used in accordance with this invention, outperform the link that uses 10 G components.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

1. An optical communication link for communicating at a given data rate comprising:
an optical transmitter and an optical receiver configured to communicate over an optical link at said data rate;
at least one of said optical transmitter or said optical receiver further comprising at least one low speed device; and
said optical receiver further comprising an equalizer for compensating signal distortion introduced by said low speed device.

2. The system of claim 1, wherein said communication is effected using NRZ pulses.

3. The system of claim 2, wherein said transmitter comprises a linear laser driver.

4. The system of claim 3, wherein said linear laser driver is characterized as having a 3-dB electrical bandwidth less than ¾ of the data rate.

5. The system of claim 2, wherein said optical transmitter comprises a laser characterized as having a 20%-80% rise time greater than ½ bit period.

6. The system of claim 2, wherein said optical transmitter comprises a laser characterized as having a 20%-80% fall time greater than ½ bit period.

7. The system of claim 2, wherein said optical transmitter comprises a laser characterized as having a relaxation oscillation frequency less than ¾ of the data rate

8. The system of claim 2, wherein said optical receiver comprises an optical-to-electrical front end converter characterized as having a 3-dB electrical bandwidth less than ¾ of the data rate.

9. The system of claim 1 wherein said communication is effected using four-level pulse amplitude modulation.

10. The system of claim 1, wherein said data rate of the communication link is at least 8.5 Gbps.

11. An optical communication link for communicating at a given data rate comprising:
optical transmitter means and optical receiver means for communicating over an optical link at said data rate;
at least one of said optical transmitter means or said optical receiver means further comprising at least one low speed device means for operating at a data rate less than said given data rate; and
said optical receiver further comprising equalizer means for compensating signal distortion introduced by said low speed device means.

12. The system of claim 11, wherein said communication is effected using NRZ pulses.

13. The system of claim 12, wherein said optical transmitter means further comprises linear laser driver means.

14. The system of claim 13, wherein said linear laser driver means is characterized as having a 3-dB electrical bandwidth less than ¾ of the data rate.

15. The system of claim 12, wherein said optical transmitter means comprises laser means characterized as having a 20%-80% rise time greater than ½ bit period.

16. The system of claim 12, wherein said optical transmitter means comprises laser means characterized as having a 20%-80% fall time greater than ½ bit period.

17. The system of claim 12, wherein said optical transmitter means comprises laser means characterized as having a relaxation oscillation frequency less than ¾ of the data rate

18. The system of claim 12, wherein said optical receiver means comprises optical-to-electrical front end converter means characterized as having a 3-dB electrical bandwidth less than ¾ of the data rate.

19. The system of claim 11 wherein said communication is effected using four-level pulse amplitude modulation.

20. The system of claim 11, wherein said data rate of the communication link is at least 8.5 Gbps.
